(19) United States
(12) Patent Application Publication
(10) Pub. No.: US 2002/0057580 A1
(43) Pub. Date: May 16, 2002

(54) Process and device for supplying electrical energy to an electronic circuit and to a power-demanding facility controlled by this circuit

(76) Inventors: Gilles Morey, Saint Ismier (FR); Thierry Arnol, Gieres (FR)

Correspondence Address: YOUNG & THOMPSON, 745 SOUTH 23RD STREET 2ND FLOOR, ARLINGTON, VA, 22202

(21) Appl. No.: 09/985,565

(22) Filed: Nov. 5, 2001

(30) Foreign Application Priority Data
Nov. 3, 2000 (FR) 00 14131

(51) Int. Cl. H02M 1/00

(52) U.S. Cl. 363/3

(57) ABSTRACT

Process and device for supplying an electronic circuit and for supplying a power-demanding facility controlled by this circuit, with electrical energy originating from at least two batteries, the electronic circuit comprising battery switching elements adapted to place these batteries in parallel or in series, the facility being subjected to controlled operating phases. The batteries are connected in series or in parallel as a function of their state with respect to two thresholds and the energy-demanding facility is controlled so as to operate according to two modes as a function of the state of the batteries.

The present invention relates to a process and a device for supplying an electronic circuit and for supplying a power-demanding facility controlled by this circuit, with electrical energy originating from at least two autonomous sources such as batteries.

In particular, in the case of alarm systems for the protection of persons and goods, which comprise components linked together by radio signals, it is advantageous for these components to be autonomous and supplied from batteries.

Certain of these components comprise electronic circuits which consume little electrical energy but which are adapted to control facilities whose electrical energy consumption is relatively large, the electronic circuits being supplied in full or in part continuously whereas the facilities which consume considerable amounts of electrical energy are operated occasionally and for a relatively short duration.

Such is the case in particular for alarm signalling components which comprise an electronic circuit for receiving and processing radio signals and in particular a sound-emitting siren controlled by this circuit.

Although it is known, in particular through patent U.S. Pat. No. 5,121,046, to use series or parallel arrangements of two batteries, such arrangements are not however sufficiently tailored to be adapted for example to the components of an alarm system such as described above

The aim of the present invention is to propose a supply process and device which make it possible both to adapt the coupling of the batteries not only as a function of the electrical energy demands of the electronic circuit but also to adapt imposed operating states or modes of the power-demanding facility as a function of the modes of coupling of the batteries.

Accordingly, the subject of the present invention is a process for supplying an electronic circuit and for supplying a power-demanding facility controlled by this circuit, with electrical energy originating from at least two batteries, the said electronic circuit comprising battery switching means adapted to place these batteries in parallel or in series, the said facility being subjected to controlled operating phases.

The process according to the invention consists:

in fixing, for each battery, a high threshold (S1) and a low threshold (S2) of voltage determining a first state when the voltage is above the high threshold, a second state when the voltage lies between the high threshold and the low threshold and a third state when the voltage is below the low threshold;

in detecting the voltage of the batteries and in comparing these voltages with the said thresholds;

in fixing at least two operating states of the said facility wherein this facility is capable of generating at least one high level and one low level of power.

The process according to the invention also consists, outside of the operating phases of the said facility:

in placing the batteries in parallel when the voltage of the batteries is detected to be above their high threshold or when the voltage of one of the batteries is detected to be below its low threshold;

and in placing the batteries in series when the voltage across the terminals of one of the batteries lies between its corresponding high (S1) and low (S2) thresholds and when the voltage across the terminals of the other battery is above its corresponding low threshold (S2).

The process according to the invention furthermore consists, during the operating phases of the said facility:

in placing the batteries in series if the voltage of each of the batteries is detected to be above its low threshold or in placing the batteries in parallel when the voltage of one of the batteries is below its low threshold;

and in placing the facility in its operating state at its aforesaid high level when the voltage of each of the batteries is detected to be above their high threshold or in placing the facility in its operating state at its aforesaid low level when the voltage of at least one of the batteries is detected to be below its high threshold.

The process according to the invention can advantageously consist in detecting the state of the batteries periodically outside of the operating phases of the said facility, then in placing the batteries in parallel or in series, and consist, following an enabling command for an operating phase of the said facility, in detecting the state of the batteries, then in placing the batteries in series or in parallel and in placing the facility in its operating state at its high level or at its low level.

The subject of the present invention is also a device for supplying an electronic circuit and for supplying a power-demanding facility controllable by this circuit, with electrical energy originating from at least two batteries, the said electronic circuit comprising battery switching means adapted to produce a series arrangement or a parallel arrangement of the batteries so as to supply the said electronic circuit and the said controllable facility, the said facility being subjected to controlled operating phases, in particular for the implementation of the above process.

According to the invention, the said electronic circuit furthermore comprises:

means of adaptation for operating the said controllable facility according to at least two operating states in which this facility is capable of demanding at least one high level and one low level of power;

means of comparison for comparing the voltage of the batteries respectively with a high threshold and with a low threshold of voltage;

and drive means linked to the said means of comparison and capable of receiving a control command for the said controllable facility, these drive means being adapted so as to selectively control the said switching means and the said means of adaptation.

According to the invention, the said electronic circuit and the said controllable facility are preferably supplied via diodes.

According to the invention, the means delivering the said control command to the said drive means can advantageously comprise a radio receiver.

According to the invention, the said facility can advantageously comprise signalling means such as sound means or luminous means.

According to the invention, the device may furthermore comprise means for delivering a battery state signal.

According to the invention, the device may also comprise a radio transmitter making it possible to transmit the said battery state signal.

The present invention will be better understood on studying a device for supplying an electronic circuit and a facility which is to be controlled by this circuit, constituting in particular a signalling component of an alarm system for monitoring persons and goods, described by way of nonlimiting examples and illustrated by the drawing in which:

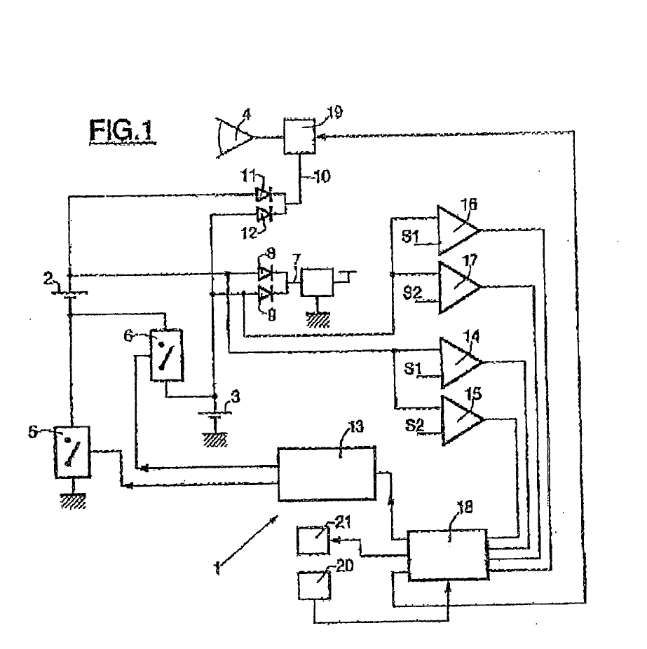

FIG. 1 represents an electronic diagram of a device according to the invention; and

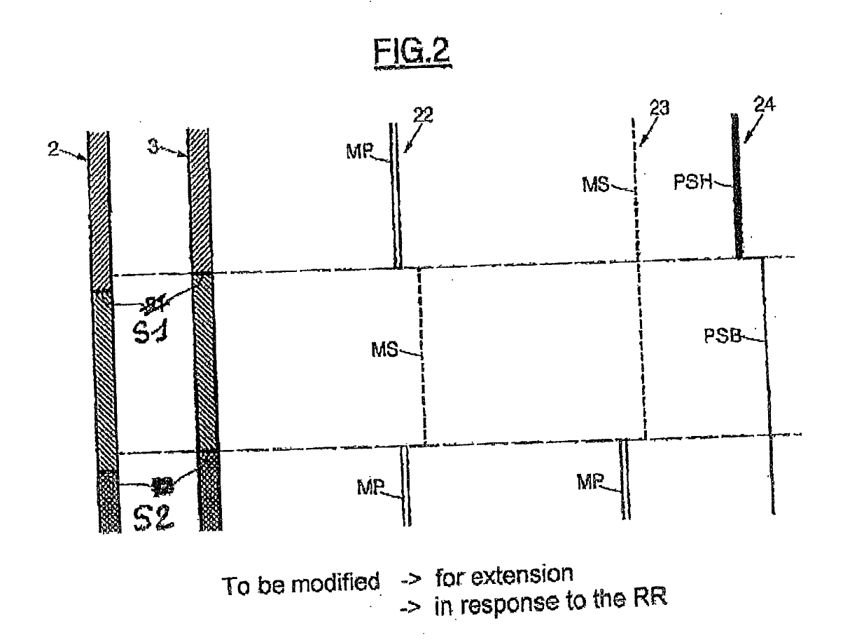

FIG. 2 represents, in the form of charts, operating modes of this device.

Referring to FIG. 1, one sees that represented therein is an electronic circuit 1 capable of being supplied with electrical energy by two batteries 2 and 3 so as to operate at least in part uninterruptedly and adapted to control the supplying by these batteries 2 and 3 of a power-demanding facility such as a siren 4 for a duration, generally specified, following a control command.

The electronic circuit 1 is made up as follows.

The (−) pole of the battery 2 is linked to earth via a controllable breaker 5 and is linked to the (+) pole of the battery 3 via a controllable breaker 6, the (−) pole of the battery 3 being linked to earth. The (+) poles of the batteries 2 and 3 are linked on the one hand to a line 7 for supplying the elements of the electronic circuit 1 via diodes 8 and 9 respectively and on the other hand to a line 10 for supplying the siren 4 via diodes 11 and 12, respectively.

Thus, when the breaker 5 is operated so as to be placed in the closed position and the breaker 6 is operated so as to be placed in the open position, the batteries 2 and 3 are placed in parallel (MP) on the one hand between the earth and the supply line 7 and on the other hand between the earth and the supply line 10.

When the breaker 5 is operated so as to be placed in the open position and the breaker 6 is operated so as to be placed in the closed position, the batteries 2 and 3 are wired in series (MS) on the one hand between the earth and the supply line 7 and on the other hand between the earth and the supply line 10.

To selectively operate the breakers 5 and 6 in the manner just described, the electronic circuit 1 comprises a switching circuit 13.

Moreover, the (+) pole of the battery 2 is linked on the one hand to an input of a comparator 14 whose other input receives a voltage value corresponding to a high voltage threshold S1 and on the other hand to an input of a comparator 15 whose other input receives a voltage value corresponding to a low voltage threshold S2

In the same way, the (+) pole of the battery 3 is linked on the one hand to an input of a comparator 16 whose other input receives a voltage value corresponding to a high voltage threshold S1 and on the other hand to an input of a comparator 17 whose other input receives a voltage value corresponding to a low voltage threshold S2.

The outputs of the comparators 14-17 are linked to a drive circuit 18 whose control output is linked to the switching circuit 13 and another output of which is linked to the input of an adaptation circuit 19 mounted on the supply line 10 for the siren 4.

The adaptation circuit 19 is designed such that the siren 4 operates according to two modes or states, one for delivering a high sound power PSH and the other for delivering an attenuated sound power PSB.

The drive circuit 18 furthermore exhibits an input which is linked to the output of a detection circuit 20 capable of delivering a control command thereto. For example, the detection circuit 20 consists of a receiver of radio signals capable of detecting a radio command for controlling the siren 4.

The switching circuit 13 and the drive circuit 18 may be programmed to operate as follows.

First case: The detection circuit 20 does not deliver any control command to the drive circuit 18.

The drive circuit periodically interrogates or investigates the outputs of the comparators 14-17.

According to a first situation, if the comparators 14 and 16 deliver a signal signifying that the voltage across the terminals of the batteries 2 and 3 is above the corresponding high threshold S1, the drive circuit 18 operates the switching circuit 13 which operates the breakers 5 and 6 in such a way as to place or maintain the batteries 2 and 3 in parallel (MP) as described previously.

According to a second situation, if the aforesaid comparators deliver signals signifying that at least the voltage across the terminals of one of the batteries 2 and 3 lies between its corresponding high S1 and low S2 thresholds and if the aforesaid comparators deliver signals signifying that the voltage across the terminals of the other battery is above its corresponding low threshold S2, the drive circuit 18 operates the switching circuit 13 so as to place or maintain the breakers 5 and 6 in their position corresponding to the series arrangement (MS) of the batteries 2 and 3, as described previously.

According to a third situation, if the comparator 15 delivers a signal signifying that the voltage of the battery 2 is below the corresponding low threshold S2 or if the comparator 17 delivers a signal signifying that the voltage across the terminals of the battery 3 is below the corresponding low threshold S2, the drive circuit 18 operates the switching circuit 13 in such a way as to place or maintain the breakers 5 and 6 in their position corresponding to the parallel arrangement (MP) of the batteries 2 and 3, as described previously.

In the situations just described, which are illustrated by the chart 22 of FIG. 2, the arrangement of the batteries 2 and 3 which is chosen by the drive circuit 18 following a phase of investigation of the outputs of the comparators 14-17 is maintained until the following phase of investigation.

Second case: The detection circuit 20 delivers a control command to the drive circuit 18.

Immediately, the drive circuit 18 investigates the outputs of the comparators 14-17.

If the two comparators 14 and 16 deliver signals signifying that the voltage across the terminals of the batteries 2 and 3 is above their corresponding high thresholds S1, the drive circuit 18 operates the switching circuit 13 in such a way as to place or maintain the breakers 5 and 6 in their position corresponding to the series arrangement (MS) of the batteries 2 and 3, as described previously, and not to the parallel arrangement of the first situation mentioned above.

At the same time, the drive circuit 18 operates the adaptation circuit 19 in such a way as to place the siren 4 in its operating mode at a high power level (PSH).

Insofar as the second and third situations described above occur, the drive circuit 18 operates the switching circuit 13 in such a way as to place or maintain the breakers 5 and 6, as indicated in the description of the first case.

At the same time, the drive circuit 18 operates the adaptation circuit 19 in such a way as to place the siren 4 in its attenuated operating mode or state (PSB).

The above two situations for the wiring up of the batteries are illustrated by the chart 23 and the above two operating modes of the siren 4 are illustrated by the chart 24 of FIG. 2.

Moreover, the drive circuit 18 exhibits an output linked to a transmission circuit 21 for example a radio signal transmitter, in such a way as to deliver signals corresponding to the states of batteries 2 and 3, which signals are delivered thereto by the comparators 14-17.

It follows from the foregoing that the electronic circuit 1 makes it possible to choose the series and parallel arrangements of the batteries 2 and 3 in such a way as to be able to benefit for as long as possible from their capacity to deliver current to the elements of the electronic circuit 1 itself, the facilities consisting of the siren 4 and to the transmitter 21, whilst protecting these batteries from one another.

In a particular mode of execution, the aforesaid thresholds may be chosen as follows.

If the voltages of the batteries 2 and 3 are below the corresponding high thresholds S1, the batteries 2 and 3 are regarded as partially or almost spent.

If the voltages of the batteries 2 and 3 are below the corresponding low thresholds S2, the batteries 2 and 3 are regarded as out of service or bereft of their capacity.

The present invention is not limited to the example described above. Variant embodiments are possible without departing from the scope defined by the appended claims.

1. Process for supplying an electronic circuit and for supplying a power-demanding facility controlled by this circuit, with electrical energy originating from at least two batteries, the said electronic circuit comprising battery switching means adapted to place these batteries in parallel or in series, the said facility being subjected to controlled operating phases, characterized in that it consists:
in fixing, for each battery (2, 3), a high threshold (S1) and a low threshold (S2) of voltage determining a first state when the voltage is above the high threshold, a second state when the voltage lies between the high threshold and the low threshold and a third state when the voltage is below the low threshold;
in detecting the voltage of the batteries and in comparing these voltages with the said thresholds;
in fixing at least two operating states of the said facility (4) wherein this facility is capable of generating at least one high level (PSH) and one low level (PSB) of power;
that it consists, outside of the operating phases of the said facility (4):
in placing the batteries in parallel (MP) when the voltage of the batteries is detected to be above their high threshold or when the voltage of one of the batteries is detected to be below its low threshold;
and in placing the batteries in series (MS) when the voltage across the terminals of one of the batteries lies between its corresponding high (S1) and low (S2) thresholds and when the voltage across the terminals of the other battery is above its corresponding low threshold (S2);
and that it consists, during the operating phases of the said facility:
in placing the batteries in series (MS) if the voltage of each of the batteries is detected to be above its low threshold (S2) or in placing the batteries in parallel (MP) when the voltage of one of the batteries is below its low threshold (S2);
and in placing the facility (4) in its operating state at its aforesaid high level (PSH) when the voltage of each of the batteries is detected to be above their high threshold (S1) or in placing the facility in its operating state at its aforesaid low level (FSB) when the voltage of at least one of the batteries is detected to be below its high threshold (S1).

2. Process according to claim 1, characterized in that it consists in detecting the state of the batteries periodically outside of the operating phases of the said facility (4), and that it consists, following a control command for an operating phase of the said facility (4), in detecting the state of the batteries and in controlling the said facility.

3. Device for supplying an electronic circuit and for supplying a power-demanding facility controllable by this circuit, with electrical energy originating from at least two batteries, the said electronic circuit comprising battery switching means adapted to produce a series arrangement or a parallel arrangement of the batteries so as to supply the said electronic circuit and the said controllable facility, the said facility being subjected to controlled operating phases, in particular for the implementation of the process according to any one of the preceding claims, characterized in that the said electronic circuit comprises:
means of adaptation (19) for operating the said controllable facility according to at least two operating states in which this facility is capable of demanding at least one high level and one low level of power (PSH, PSB);
means of comparison (14-17) for comparing the voltage of the batteries respectively with a high threshold and with a low threshold of voltage;
and drive means (18) linked to the said means of comparison (14-17) and capable of receiving a control command (20), these drive means being adapted so as to selectively control the said switching means (13) and the said means of adaptation (19).

4. Process according to claim 3, characterized in that the said electronic circuit and the said controllable facility are supplied via diodes (8, 9, 11, 12).

5. Device according to one of claims 3 and 4, characterized in that the means delivering the said control command to the said drive means (18) comprise a radio receiver (20).

6. Device according to any one of claims 3 to 5, characterized in that the said facility (4) comprises signalling means such as sound means or luminous means.

7. Device according to any one of claims 3 to 6, characterized in that it comprises means (21) for delivering a battery state signal.

8. Device according to claim 7, characterized in that it comprises a radio transmitter (21) making it possible to transmit the said battery state signal.
